(19) United States
(12) Patent Application Publication
(10) Pub. No.: US 2019/0061769 A1
(43) Pub. Date: Feb. 28, 2019

(54) SYSTEM AND METHOD FOR DRIVER ENGAGEMENT ASSESSMENT

(71) Applicant: GM GLOBAL TECHNOLOGY OPERATIONS LLC, Detroit, MI (US)

(72) Inventor: Satish Panse, Clawson, MI (US)

(73) Assignee: GM GLOBAL TECHNOLOGY OPERATIONS LLC, Detroit, MI (US)

(21) Appl. No.: 15/686,599

(22) Filed: Aug. 25, 2017

(51) Int. Cl. B60W 40/09; B60W 30/09; B62D 15/02; G06T 7/73; G06K 9/00

(52) U.S. Cl. CPC B60W 40/09; B60W 30/09; B62D 15/021; B60W 2040/0818; G06K 9/00798; G06K 9/00845; B60W 2540/18; G06T 7/73

(57) ABSTRACT

Methods and systems are provided for determining a driver engagement status used in controlling a vehicle. In one embodiment, a computer implemented method includes: detecting the presence of lane markers in proximity to the vehicle; determining a vehicle lateral position based on the lane markers; determining an ideal vehicle path based on the lane markers; and determining a driver engagement status based on the vehicle lateral position, and the ideal vehicle path.

### TECHNICAL FIELD

The technical field generally relates to vehicle control, and more particularly relates to methods and systems for driver engagement of a vehicle.

### INTRODUCTION

A vehicle may have one or more driver assistance systems. Several such systems do not directly influence the driving and steering of the vehicle, for example a blind spot monitor, adaptive light control, rain sensor, tire pressure monitoring, traffic sign recognition, etc. Others can influence the driving operation of a vehicle and even take over control of the vehicle from the driver, for example, adaptive cruise control, automatic parking, collision avoidance and emergency breaking system, intelligent speed adaptation, lane change assistance, lane keeping assistance, etc.

These driver assistance systems can assist the driver in perceiving the environment, i.e. traffic, road conditions, weather, surroundings, etc., and in acting upon the actual and changing environmental conditions. In order to perform the desired function, some driver assistance systems monitor the driver and act upon changes, or the lack of changes, in the driver's behavior, posture, etc. One example for such a responsive assistant is a driver drowsiness detector.

Assistance systems that can influence the driving and steering of a vehicle often require to know whether the driver is steering the vehicle, i.e. whether the driver has one or both hands on the steering wheel. Such detectors are called hands on-off detectors. Current hands on-off detection is used to indicate driver engagement associated with lateral motion control of the vehicle. The driver engagement information can be used by active safety features to decide when specific function will be enabled or disabled, and one or more actions can be triggered. Hands on-off status can easily be detected when the driver has to actively steer the vehicle, i.e. when the steering wheel has to be actuated due to a curved road condition, heavy traffic, or windy weather condition. The force applied to the steering wheel can be detected and driver steering torque information and driver steering angle information can be obtained.

However, detection is more difficult when the driver has to actuate the steering wheel less, due to relatively straight road conditions, low traffic volume, and steady weather conditions. In such situations, driver actuation of the steering wheel might be very light and rare, and aforementioned hands on-off detectors might falsely indicate a “hands off” status. Such false positive identification in certain circumstances can cause driver annoyance and impacts customer satisfaction.

Accordingly, it is desirable to provide improved methods and systems for determining driver engagement. Furthermore, other desirable features and characteristics of the present invention will become apparent from the subsequent detailed description and the appended claims, taken in conjunction with the accompanying drawings and the foregoing technical field and background.

### SUMMARY

Methods and systems are provided for determining a driver engagement status used in controlling a vehicle. In one embodiment, a computer implemented method includes: detecting the presence of lane markers in proximity to the vehicle; determining a vehicle lateral position based on the lane markers; determining an ideal vehicle path based on the lane markers; and determining a driver engagement status based on the vehicle lateral position, and the ideal vehicle path.

In one embodiment, a system includes a first module that, by a processor, detects the presence of lane markers in proximity to the vehicle; a second module that, by a processor, determines a vehicle lateral position based on the lane markers; a third module that, by a processor, determines an ideal vehicle path based on the lane markers; and a fourth module that, by a processor, determines a driver engagement status based on the vehicle lateral position, and the ideal vehicle path.

In one embodiment, a vehicle includes a sensor system configured to detect lane markers, and driver steering input; and a controller configured to determine a vehicle lateral position and an ideal vehicle path on the basis of the lane markers, and a driver engagement status based on the driver steering input, the vehicle lateral position, and the ideal vehicle path.

### BRIEF DESCRIPTION OF THE DRAWINGS

The exemplary embodiments will hereinafter be described in conjunction with the following drawing figures, wherein like numerals denote like elements, and wherein:

FIG. 1 is a functional block diagram illustrating a vehicle having a driver engagement system, in accordance with various embodiments;

FIG. 2 is a dataflow diagram illustrating a driver engagement system, in accordance with various embodiments; and

FIG. 3 is a flowchart illustrating a method in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

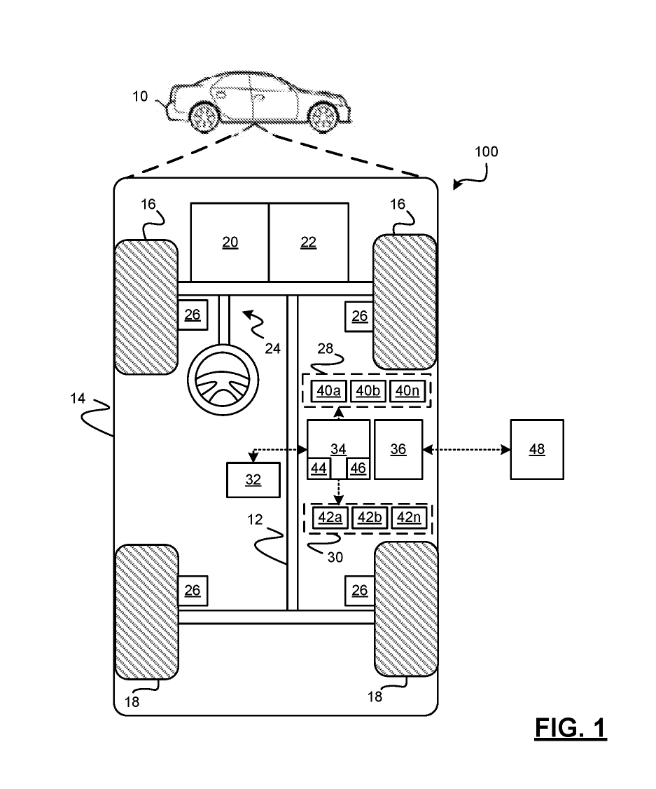

With reference to FIG. 1, a vehicle 10 having a driver engagement system 100 is shown in accordance with various embodiments. In general, the driver engagement system 100 receives and processes sensor data to determine an engagement status of a driver. The engagement status is thereafter used by one or more active safety systems to control the operation of the vehicle 10. As will be discussed in more detail below, the driver engagement system 100 compares a lateral position of the vehicle 10 within a detected lane and with an ideal path within the lane to determine a threshold driver input value; and compares the threshold driver input value with an actual driver steering input value to determine the engagement status. In various embodiments, the driver input value relates to a sensed input that the driver exerts on a steering system 24 of the vehicle 10, such as, but not limited to steering angle, and steering torque.

As depicted in the example of FIG. 1, the vehicle 10 is an automobile and generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16 and 18 are each rotationally coupled to the chassis 12 near a respective corner of the body 14. The vehicle 10 is depicted in the illustrated embodiment as a passenger car, but it should be appreciated that any other vehicle including motorcycles, trucks, sport utility vehicles (SUVs), recreational vehicles (RVs), marine vessels, aircraft, etc., can also be used.

As shown, the vehicle 10 generally includes a propulsion system 20, a transmission system 22, the steering system 24, a brake system 26, a sensor system 28, an actuator system 30, at least one data storage device 32, and at least one controller 34. The propulsion system 20 may, in various embodiments, include an internal combustion engine, an electric machine such as a traction motor, and/or a fuel cell propulsion system. The transmission system 22 is configured to transmit power from the propulsion system 20 to the vehicle wheels 16 and 18 according to selectable speed ratios. According to various embodiments, the transmission system 22 includes a step-ratio automatic transmission, a continuously-variable transmission, or other appropriate transmission. The brake system 26 is configured to provide braking torque to the vehicle wheels 16 and 18. The brake system 26 may, in various embodiments, include friction brakes, brake by wire, a regenerative braking system such as an electric machine, and/or other appropriate braking systems. The steering system 24 influences a position of the of the vehicle wheels 16 and 18.

The sensor system 28 includes one or more sensing devices 40a-40n that sense observable conditions of the exterior environment and/or the interior environment of the vehicle 10. In various embodiments, at least some of the sensing devices 40a-40n include, but are not limited to, radars, lidars, global positioning systems, optical cameras, thermal cameras, ultrasonic sensors, and/or other sensors that generate sensor data related to the exterior environment of the vehicle 10. In various embodiments, at least some of the sensing devices 40a-40n include, but are not limited to, torque sensors, position sensors, and/or angle sensors that generate sensor data related to the steering system 24. In various embodiments, at least some of the sensing devices 40a-40n include, vehicle sensors, such as, but not limited to, vehicle speed sensors, brake sensors, etc.

The actuator system 30 includes one or more actuator devices 42a-42n that control one or more vehicle features such as, but not limited to, the propulsion system 20, the transmission system 22, the steering system 24, and the brake system 26. The data storage device 32 stores data for use in controlling the vehicle 10. In various embodiments, the data storage device 32 stores defined maps of the navigable environment. In various embodiments, the defined maps may be predefined by and obtained from a remote system. For example, the defined maps may be assembled by the remote system and communicated to the vehicle 10 (wirelessly and/or in a wired manner) and stored in the data storage device 32. As can be appreciated, the data storage device 32 may be part of the controller 34, separate from the controller 34, or part of the controller 34 and part of a separate system.

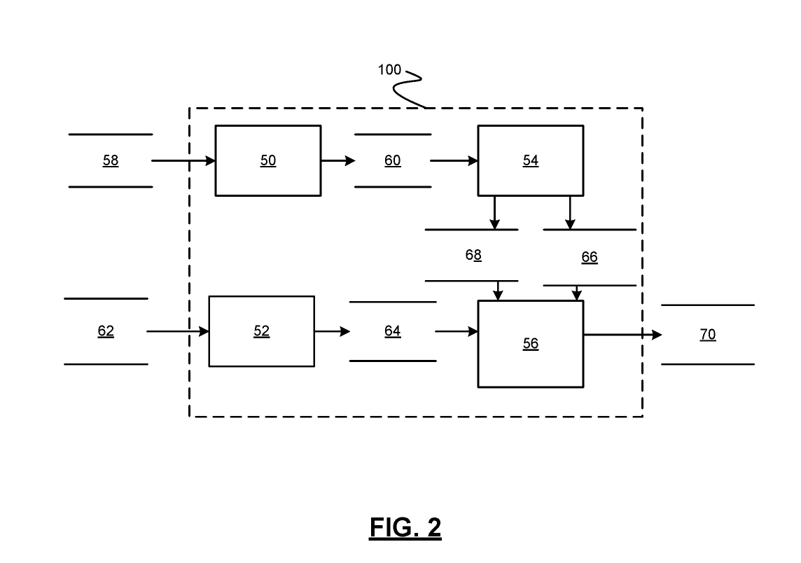

The communication system 36 is configured to wirelessly communicate information to and from other entities 48, such as but not limited to, other vehicles (“V2V” communication,) infrastructure (“V2I” communication), remote systems, and/or personal devices (described in more detail with regard to FIG. 2). In an exemplary embodiment, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

The controller 34 includes at least one processor 44 and a computer readable storage device or media 46. The processor 44 can be any custom made or commercially available processor, a central processing unit (CPU), a graphics processing unit (GPU), an auxiliary processor among several processors associated with the controller 34, a semiconductor based microprocessor (in the form of a microchip or chip set), a macroprocessor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the vehicle 10.

The instructions may include one or more separate programs, each of which comprises an ordered listing of executable instructions for implementing logical functions. The instructions, when executed by the processor 44, receive and process signals from the sensor system 28, perform logic, calculations, methods and/or algorithms for controlling the components of the vehicle 10, and generate control signals to the actuator system 30 to control the components of the vehicle 10 based on the logic, calculations, methods, and/or algorithms. Although only one controller 34 is shown in FIG. 1, embodiments of the vehicle 10 can include any number of controllers 34 that communicate over any suitable communication medium or a combination of communication mediums and that cooperate to process the sensor signals, perform logic, calculations, methods, and/or algorithms, and generate control signals to control features of the vehicle 10.

As will be discussed in more detail below, one or more instructions of the controller 34 are embodied in the driver engagement system 100.

With reference now to FIG. 2, a dataflow diagram illustrates the driver engagement system 100 in accordance with various embodiments. Various embodiments of the driver engagement system 100 according to the present disclosure may include any number of sub-modules. As can be appreciated, the sub-modules shown in FIG. 2 may be combined and/or further partitioned to similarly determine an engagement status of a driver of the vehicle 10. Inputs to the driver engagement system 100 may be received from the sensor system 28, received from other controllers (not shown) of the vehicle 10, and/or determined by other sub-modules (not shown) of the controller 34. Furthermore, the inputs may be subjected to preprocessing, such as sub-sampling, noise-reduction, normalization, feature-extraction, missing data reduction, and the like prior to use by the driver engagement system 100. In various embodiments, the driver engagement system 100 includes a lane marker detection module 50, a driver input detection module 52, a path/position determination module 54, and a driver engagement determination module 56.

The lane marker detection module 50 processes sensor data 58 from at least one sensor of the sensor system 28 to detect lane markers and to produce lane marker information based thereon. Depending on the nature of the lane marker and the weather and lighting conditions, various sensor data and/or methods of detecting the lane markers can be implemented. For example, image data can be processed using image processing techniques to identify the presence and or type of lane markers. In another example, material data can be processed using material detection methods such as metal detection, electromagnetic detection, etc. to identify the presence and/or type of lane markers. As can be appreciated, other methods of detecting lane markers can be implemented in various embodiments.

Once the lane markers have been identified, the lane marker detection module 50 determines a position of the lane marker relative to the vehicle 10 (e.g., distance to the left of the vehicle 10, distance to the right of the vehicle 10, etc.). For example, in various embodiments, the lane marker detection module 50 further processes the sensor data 58 or other sensor data such as lidar data, radar data, etc. to determine a position of the detected lane marker relative to the vehicle 10 and according to a coordinate system of the vehicle 10. The lane marker detection module 50 generates marker data 60 that includes the lane marker positions.

The driver input detection module 52 processes sensor data 62 from one or more sensors of the sensor system 28 to detect a steering input from the driver, such as, driver applied torque, or steering angle. For example, torque data from the steering system 24 and/or steering angle data sensed from the steering system 24 can be processed to determine an amount of driver input. The driver input detection module 42 generates driver input data 64 based on the determined amount of driver input.

The position/path determination module 54 receives as input the marker data 60. Based on the marker data 60, the position/path determination module 54 determines lane boundaries; and further determines an actual position 66 of the vehicle 10 within the determined lane boundaries and an ideal path 68 of the vehicle 10 within the determined lane boundaries. For example, in various embodiments, the position/path determination module 54 determines the lane boundaries from lane markers identified to the left of the vehicle 10 and left front of the vehicle, and the lane markers identified to the right of the vehicle 10 and the right front of the vehicle. In another example, in various embodiments, the position/path determination module 54 determines the actual lateral position of the vehicle 10 within the lane based on position of the detecting sensors relative to the position of the lane markers. As can be appreciated, other methods of detecting the lateral position of the vehicle 10 can be implemented in various embodiments, as the disclosure is not limited to the present examples.

The position/path determination module 54 further determines an ideal path of the vehicle 10 within the defined lane boundaries. For example, the ideal path 68 can be set based on preferences or parameters that are predefined, defined by a user, and/or determined in realtime based on sensor data. For example, the preferences or parameters can indicate a center position within a lane. In another example, the preferences or parameters can be defined based on detected available space on one or both sides of the used lane. In various embodiments, the detected available space is based on detected other vehicles, pot holes, road damage, rain puddles, ice, snow, wind, or other factors that commonly influence the travel of the vehicle 10. In another example, the preferences or parameters can be defined based on driving maneuvers such as when the vehicle is maneuvering a corner, etc.

In various embodiments, the ideal path 68 includes a lateral range. The range can encompass the whole lane, the lane with a safety border on all sides, the lane with a safety border on one side, i.e. where other vehicles are driving, or the like. In various embodiments, the ideal vehicle path 68 takes into account a range of space where a lane keeping assistant would not interfere with the driving. The above have been detailed as examples only, and a person skilled in the art will appreciate that a vast number of variations exist.

The driver engagement determination module 56 receives as input the driver input data 64, the actual position data 66, and the ideal path data 68 and determines an engagement status 70 of the driver. For example the driver engagement determination module 56 determines a required steering torque and/or a required steering angle, which are required to maintain the ideal vehicle path 68 given the actual position 66. The driver engagement determination module 56 then compares the required steering torque and/or the required steering angle to the actual driver steering torque and the driver steering angle, respectively, to determine the driver engagement status 70.

As can be appreciated, other vehicle dynamics data can be considered in determining the driver engagement status 70, such as, but not limited to, speed, mileage, internal data detected by the sensor system 28, etc. In addition or as an alternative, a change in the required steering torque can be considered in determining the driver engagement status 70.

Once the driver engagement status 70 is determined, a message and/or signal are communicated to another part of the vehicle 10 or to the remote system 48; thereby, enabling other vehicle functions to operate based on a driver engagement status. Such other vehicle functions can include, but are not limited to, active safety systems, like an emergency breaking system or a lane keeping assistant. In various embodiments, a warning message could be displayed on an information display system, an audio, visual, or physical warning can be produced, a physical warning being for example a vibration or a gust of wind from the ventilation system, etc. In various embodiments, a message is transmitted from the vehicle to some other person, vehicle, or location. In various embodiments, one or more of these responses are produced simultaneously or as an escalating series.

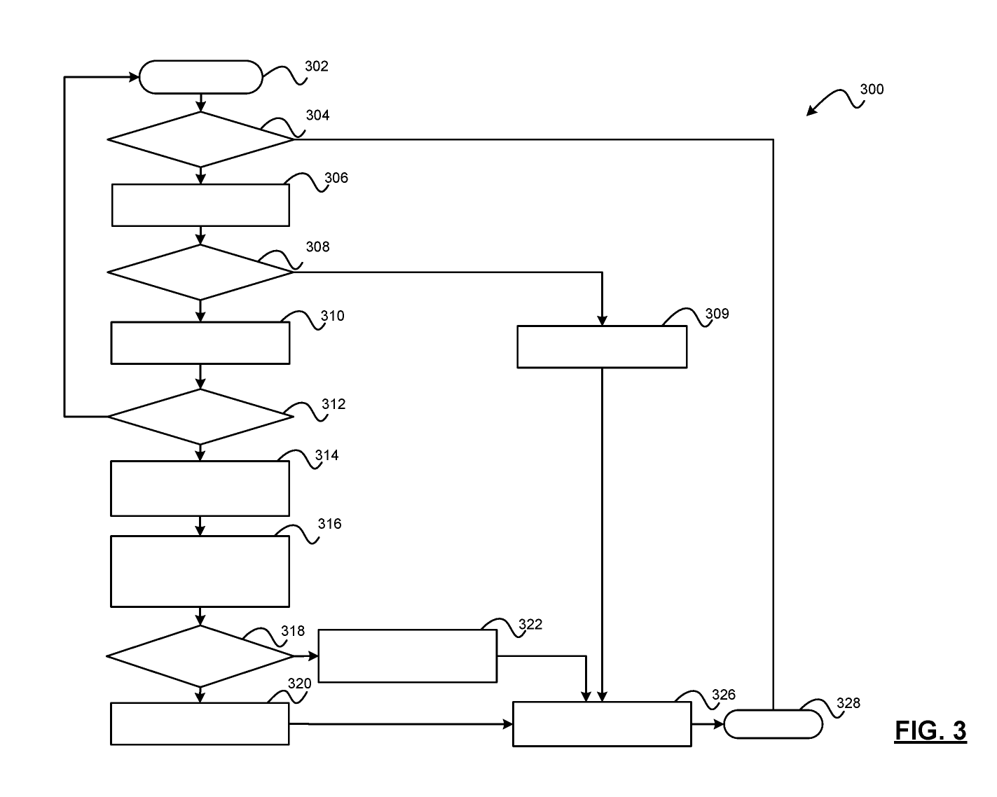

With reference now to FIG. 3 and with continued reference to FIGS. 1 and 2, a flowchart illustrates a method that may be performed by the driver engagement system 100 in accordance with various embodiments. As can be appreciated in light of the disclosure, the order of operation within the method is not limited to the sequential execution as illustrated in FIG. 3, but may be performed in one or more varying orders as applicable and in accordance with the present disclosure. As can further be appreciated, the method of FIG. 3 may be scheduled to run at predetermined time intervals during operation of the vehicle 10 and/or may be scheduled to run based on predetermined events.

In one example, the method may begin at 302, wherein the vehicle 10 is in forward motion driven by the propulsion system. At 304, it is determined if the vehicle speed is above a threshold. If the vehicle speed is not above the threshold, the method may end at 328. If, the vehicle speed is above a threshold, the method continues at 306 where the steering torque applied by the driver is detected and evaluated at 308. If the driver applied steering torque is greater than a certain threshold for example, a first threshold, (NO at 308) the driver engagements status 70 is set to engaged at 322 and the corresponding status is communicated to active safety systems in 326. If the driver applied steering torque is less than the threshold (YES at 308) (in various embodiments, for a predetermined time period (flow not shown)) it is determined whether the lane markings have been detected (e.g. by an image sensor) at 312.

If the lane markers have not been detected (NO in 312), the method 300 returns to the start 302 without a further driver engagement determination. If lane markers have been detected (YES at 312), the vehicle lateral position 66 and the ideal path 68 are determined at 314 based on the detected road lane marking and their position. The steering torque which is required to maintain the ideal vehicle path is determined at 316, for example, based on the vehicle speed or other current conditions.

If the required steering torque determined in 316 is smaller than a predetermined allowable limit for the vehicle speed (NO at 318) (e.g., where the limit is different than the threshold at 308), the driver engagement status set to engaged at 322 and the corresponding status 70 is communicated to other systems, such as active safety systems at 326. If, however, the required steering torque determined at 316 is equal to or larger than a predetermined allowable limit for the vehicle speed (YES at 318), the driver engagement status 70 is determined at 320 based on driver steering torque information, the driver steering angle information, the vehicle lateral position, and the ideal vehicle path. Also, other vehicle data can be taken into account for this determination, additionally or alternatively. Examples of such other vehicle data are vehicle acceleration, vehicle speed, propulsion command, or brake apply. The result of the determination of driver engagement status 70 is then communicated to other systems, such as active safety systems at 326. Thereafter, the method may end at 328.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A vehicle, comprising:
a sensor system configured to detect
lane markers, and
driver steering input; and
a controller configured to determine
a vehicle lateral position and an ideal vehicle path on the basis of the lane markers, and
a driver engagement status based on the driver steering input, the vehicle lateral position, and the ideal vehicle path.

2. The system of claim 1, wherein the controller is further configured to determine a driver steering input that is required to maintain the ideal vehicle path.

3. The system of claim 2, wherein the controller is further configured to determine the driver steering input that is required to maintain the ideal vehicle path based on a comparison of the vehicle lateral position and the ideal vehicle path.

4. The system of claim 2, wherein the controller is configured to compare the driver steering input and an actual driver steering input to determine the driver engagement status.

5. The system of claim 1, wherein the controller is configured to include vehicle dynamics data in the determination of driver engagement status.

6. The system of claim 1, wherein the controller is further configured to control the vehicle based on the driver engagement status and an active safety system.

7. The system of claim 1, wherein the driver steering input include driver applied torque.

8. The system of claim 1, wherein the driver steering input include steering angle.

9. A computer implemented method for determining a driver engagement status used in controlling a vehicle, comprising:
detecting the presence of lane markers in proximity to the vehicle;
determining a vehicle lateral position based on the lane markers;
determining an ideal vehicle path based on the lane markers; and
determining a driver engagement status based on the vehicle lateral position, and the ideal vehicle path.

10. The method of claim 9, further comprising determining a driver steering input that is required to maintain the ideal vehicle path, and wherein the determining the driver engagement status is based on the driver steering input required to maintain the ideal vehicle path.

11. The method of claim 10, wherein determining the driver steering input that is required to maintain the ideal vehicle path is based on a comparison of the vehicle lateral position and the ideal vehicle path.

12. The method of claim 10, further comprising comparing the driver steering input and an actual driver steering input to determine the driver engagement status.

13. The method of claim 9, wherein the determining the driver engagement status is further based on vehicle dynamics data.

14. The method of claim 9, further comprising controlling the vehicle based on the driver engagement status and an active safety system.

15. The method of claim 9, further comprising determining a driver applied torque; and wherein the determining the driver engagement status is based on the driver applied torque.

16. The method of claim 9, further comprising determining a steering angle; and wherein the determining the driver engagement status is based on the steering angle.

17. A computer implemented system for determining a driver engagement status used in controlling a vehicle, comprising:
a first module that, by a processor, detects the presence of lane markers in proximity to the vehicle;
a second module that, by a processor, determines a vehicle lateral position based on the lane markers;
a third module that, by a processor, determines an ideal vehicle path based on the lane markers; and
a fourth module that, by a processor, determines a driver engagement status based on the vehicle lateral position, and the ideal vehicle path.

18. The computer implemented system of claim 17, further comprising a fifth module that determines a driver steering input, and wherein the fourth module determines the driver engagement status further based on the driver steering input.

19. The computer implemented system of claim 18, wherein the driver steering input includes a driver applied torque to a steering system.

20. The computer implemented system of claim 18, wherein the driver steering input includes a steering angle of the steering system.
